(19) United States
(12) Patent Application Publication
(10) Pub. No.: US 2011/0248823 A1
(43) Pub. Date: Oct. 13, 2011

(54) ASSET IDENTIFICATION AND TRACKING SYSTEM AND METHOD

(76) Inventors: Kristian Silberbauer, Ribe (DK); Gorm Gamborg, Kolding (DK)

(21) Appl. No.: 12/755,464

(22) Filed: Apr. 7, 2010

(51) Int. Cl. H04Q 5/22

(52) U.S. Cl. 340/10.1

(57) ABSTRACT

An asset identification and tracking system includes a plurality of antennas each constructed and arranged to be mounted to one of a plurality of rack positions within an equipment rack, a receiver coupled to each of the antennas, and an antenna selector coupled to each of the antennas for selectively enabling communication between one of the antennas and the receiver. The system may further include a controller coupled to the receiver and to the antenna selector. The system may further include a data center manager coupled to the controller for identifying and tracking an asset. Each of the plurality of antennas may be configured to receive a signal emitted by a RFID tag attached to an asset mounted within the equipment rack. The receiver may include an RFID reader.

### BACKGROUND OF INVENTION

1. Field of Invention

The present disclosure relates generally to the field of asset identification and tracking, and more particularly to systems and methods for identifying rack-mountable equipment in data centers and electrical equipment rooms.

2. Discussion of Related Art

The uses, requirements, size and complexity of information technology (IT) operations continue to increase dramatically in response to the demands of information-based economies. The critical importance of IT operations to many organizations brings the recognition that IT resources must be managed in a manner that ensures their integrity and functionality. These resources comprise various assets, including computer systems, network and telecommunications equipment, power supplies, environmental controls and security devices, to name a few typical examples. To meet the needs of the organization, system administrators must be able to readily identify and locate each asset within the group of collective resources.

Traditionally many of these assets are centrally located in one or more data centers, enabling centralized control and monitoring, although these assets may also be remotely located and interconnected via a communications network. Individual assets may be identified and tracked by manual inventorying methods and devices. For example, unique identifying information is attached to each asset in the form of bar codes or radio frequency identification (RFID) tags, providing a mechanism for associating the asset (and its identity) with its installed location.

Such methods and devices typically require an administrator to physically visit each asset with a device capable of reading the identifying information. This identifying information may then be logged or recorded into a repository. However, as the number of assets increases it becomes increasingly difficult and inefficient to track individual assets in this manner. Furthermore, each time an asset is installed, removed, or relocated, the information in the repository becomes obsolete with respect to that asset unless and until a new inventory is conducted. Given the explosive expansion of physical resources used by many organizations and the increasing frequency with which those resources are deployed and reallocated, prior techniques for inventorying and managing those assets have become insufficient to meet the present demands of many IT operators.

### SUMMARY OF INVENTION

According to one embodiment, an asset identification and tracking system includes a plurality of antennas each constructed and arranged to be mounted to one of a plurality of rack positions within an equipment rack, a receiver coupled to each of the antennas, and an antenna selector coupled to each of the antennas to selectively enable communication between one of the antennas and the receiver. The system may further include a controller coupled to the receiver and to the antenna selector. The system may further include a data center manager coupled to the controller to identify and track an asset based on information received from the controller. Each of the plurality of antennas may be configured to receive a signal emitted by a RFID tag attached to an asset mounted within the equipment rack.

Each of the antennas may include a signal line and an enable line, wherein the signal line is coupled to the receiver, and wherein the enable line is coupled to the antenna selector. Each of the antennas may be configured to communicate a signal over the signal line to the receiver when an electrical current is applied, by the antenna selector, to the enable line of a respective antenna. Each of the antennas may include an enable circuit coupled to the enable line and to the signal line. The enable circuit may include a diode.

The antennas may be enclosed within one or more housings. The receiver may include an RFID reader.

According to another embodiment, a method for identifying and tracking an asset includes mounting each of a plurality of antennas in an equipment rack such that each of the antennas is configured to receive a signal from an RFID tag attached to an asset mounted at one of a plurality of rack positions within the equipment rack, installing the asset having the RFID tag at the one of the rack positions, selectively enabling one of the plurality of antennas to receive the signal from the RFID tag, and sending the signal to a receiver.

The method may include reading, by the receiver, the received signal to obtain data from the RFID tag. The method may include identifying the at least one asset based on the data. The method may include tracking a location of the at least one asset based on the data. The method may include controlling the at least one asset based on the data.

According to another embodiment, an asset identification and tracking system includes a plurality of antennas configured for mounting within an equipment rack and means, coupled to the plurality of antennas, for sensing an RFID tag associated with an asset mounted in the equipment rack and for identifying a location of the asset in the equipment rack. The system may include means for identifying the asset. The system may include means for tracking a location of the asset. The system may include means for controlling the asset.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates a block diagram of an asset identification and tracking system in accordance with one embodiment of the disclosure.

FIG. 2 illustrates a front view of an equipment rack having an asset identification and tracking system in accordance with one embodiment of the disclosure.

FIG. 3 illustrates a top view of an equipment rack having an asset identification and tracking system in accordance with one embodiment of the disclosure.

FIG. 4A illustrates a schematic diagram of an asset identification and tracking system in accordance with one embodiment of the disclosure.

FIG. 4B illustrates a schematic diagram of an enable circuit in accordance with one embodiment of the disclosure.

FIG. 5 illustrates a flow diagram of an asset identification and tracking method in accordance with one embodiment of the disclosure.

### DETAILED DESCRIPTION

Embodiments of this invention are not limited in their application to the details of construction and the arrangement of components set forth in the following description or illustrated in the drawings. Embodiments of the invention are capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

Asset inventory and management systems are used in many organizations to track and control information technology resources in both centralized and distributed installations. Many companies house servers, telecommunications equipment and the like in a myriad of equipment racks within their data centers. Inventory of these assets may be accomplished, for example, through the use of multiple bar code or RFID readers permanently (or semi-permanently) located at various asset locations and tied into a network. In this manner assets may be tracked remotely as they are installed or removed; however, at large installations the cost of providing and maintaining many such readers may become prohibitively high. Furthermore, care should be taken to ensure that the readers are configured to read each asset as it is installed or removed to avoid the problem of assets being “lost” as a result of their placement outside of the readers' ranges or any undetected movement. If the nature of asset locations is disparate (e.g., if assets are installed at locations not covered by a reader), identification and tracking of assets is, in certain instances, not possible using these methods and devices.

In many data center environments IT assets are installed in standardized equipment frames or enclosures called equipment racks, for example as defined by the EIA-310 specification. A large data center may have hundreds of equipment racks. An IT asset may comprise one or more pieces of equipment, such as servers, network routers, data storage devices, and the like. Equipment designed for installation in a rack is typically described as “rack mountable” and usually has a standard width, for example 19 or 23 inches, which is compatible with the width of the rack. Such equipment is also often designed to have a standard height measured in multiples of one rack unit or “U,” which is typically 1.75 inches. Accordingly, the size of a piece of rack mounted equipment having a height of one rack unit is described as “1U”; two rack units as “2U,” etc.

At least one aspect of the invention relates to a system for identifying rack-mountable equipment. In at least one embodiment, each of a plurality of antennas is constructed and arranged to be mounted to a rack position within an equipment rack. The antennas are coupled to a receiver and an antenna selector. In another embodiment, a controller is coupled to the receiver and the antenna selector. In yet another embodiment, a data center manager is coupled to the controller. Each antenna may be configured to receive a signal from an RFID tag attached to an asset installed in the equipment rack at one of the rack positions.

According to another aspect, a method for identifying and tracking an asset includes mounting a plurality of antennas in an equipment rack, installing an asset having an RFID tag at one of the rack positions, selectively enabling one of the antennas to receive a signal from the RFID tag, and sending the signal to a receiver. The antennas are mounted such that each is configured to receive a signal from the RFID tag attached to an asset mounted at one of the rack positions within the equipment rack.

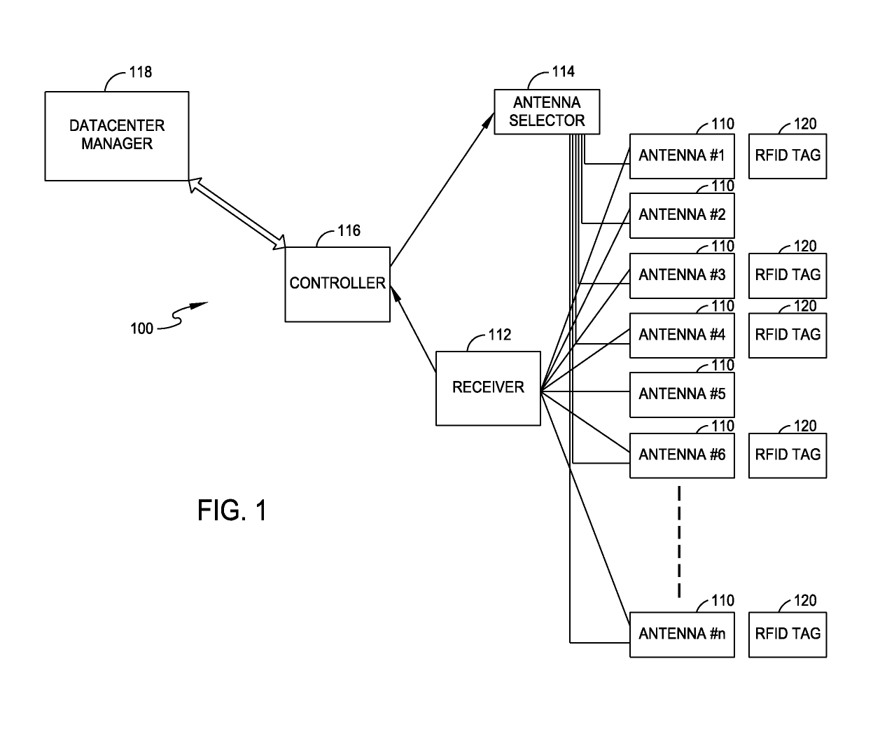

FIG. 1 depicts an exemplary asset identification system 100 having a plurality of antennas 110, a receiver 112, an antenna selector 114, a controller 116, a data center manager 118, and a plurality of RFID tags 120. Each antenna 110 may, for example, include a four- or eight-loop transducer having an inductance of approximately 1.2 microHenries (uH), which may be mounted on a printed circuit board or a metal sheet. However, it will be understood that other arrangements and configurations of the antenna 110 may be utilized. The antennas 110 may be individually enclosed in separate housings or collectively enclosed by a single housing. The antenna selector 114 is a switch for selectively enabling each antenna to communicate with the receiver 112. The controller 116 is a switched rack power distribution unit (PDU) or other device adapted to communicate with the receiver 112 and the antenna switch 114. The data center manager 118 is an automated centralized data center configuration and control manager, such as American Power Conversion Corporation's (APC's) InfraStruXure® Central Server, Part Number AP9475, adapted to communicate with the controller 116.

According to one embodiment, each antenna 110 is connected to the receiver 112 by one or more signal lines. There may be, for example, one signal line connecting all of the antennas 110 to the receiver 112 in series, or separate signal lines connecting each antenna 110 to the receiver 112 in parallel. It will be understood that other variations of connections between the antennas 110 and the receiver 112 may be employed. Each antenna 110 is also connected to the antenna selector 114 by an enable line. The antenna selector 114 is connected to the controller 116. In another embodiment, the receiver 112 and antenna selector 114 are each connected to the controller 116 over one or more control and monitoring lines. In yet another embodiment, the controller 116 is connected to the data center manager 118 over, for example, a local area network.

According to another embodiment, an RFID tag 120 is associated with an asset for uniquely identifying the respective asset. When the asset is installed in the equipment rack, the RFID tag 120 enters into the sensing range of the antenna 110 mounted at or near the rack position where the asset is located. The antenna will then receive a signal emitted by the RFID tag 120. It will be appreciated that the RFID tag 120 may be passive or battery assisted passive, and accordingly power may be applied to the antenna 110, for example by the RFID reader, in order to provoke the RFID tag 120 to emit a signal. If the RFID tag is active, the power may not be necessary.

According to one embodiment, the receiver 112 may include an RFID reader (not designated), for example a TRH031M integrated circuit (IC) chip, available from 3ALogics, or a similar device. The RFID reader extracts and processes data embedded in the signal received from the RFID tag, which data may include an RFID tag identifier, an asset identifier, and other information relating to the respective asset.

According to one embodiment, the receiver 112 is capable of reading one RFID tag 120 at a time. However, the receiver 112 may be connected to multiple antennas 110. To ensure that only one RFID tag 120 signal reaches the receiver 112 at any given moment, each antenna 110 may be individually enabled by the antenna selector 114. When the antenna 110 is enabled, the signal (if any) received by the antenna 110 is communicated to the receiver 112 over the respective signal line. When the antenna 110 is not enabled, the signal (if any) is inhibited from reaching the receiver 112.

In one embodiment, the antenna selector 114 may operate independently, for example by having an integral logic component for selecting the antennas 110 according to a programmable scheme. The scheme may, for example, include briefly enabling each antenna 110 in a circular or pre-determined pattern. In another embodiment, the controller 116 commands the antenna selector 114 to enable a particular antenna 110. It should be appreciated that other configurations and modes of antenna selection are possible when using a receiver 112 capable of reading more than one RFID tag 120 at a time.

According to one embodiment, the data extracted from the signal by the receiver 112 is communicated to the controller 116. In another embodiment, the data is further communicated from the controller 116 to the data center manager 118. The data may include, but not be limited to, RFID tag identification, asset identification, and asset location information. In one example, the data includes RFID tag identification, rack identification, and rack position based on the antenna location, which the data center manager 118 uses to identify and locate the corresponding asset. In another example, the data center manager 118 may poll the controller 116 for stored or real-time data.

According to one embodiment, to coordinate the enabling and receiving of signals from each antenna 110, the controller 116 directs the antenna selector 114 to enable one of the antennas 110 at a time. After a received signal is acquired by the controller 116 from the enabled antenna 110, the controller 116 then directs the antenna selector 114 to enable individually each of the other antennas 110. This pattern of enabling one antenna 110 at a time allows the controller 116 to acquire the signal of each antenna 110, and the pattern may be repeated in a “scanning” fashion, wherein each scan includes enabling some or all of the antennas 110. The total time required for a single scan may be one second or less, allowing the controller 116 to rapidly poll each of the antennas 110 in a repetitive manner. Because the controller 116 is therefore aware of which antenna 110 is enabled at any given time, the controller 116 is also capable of identifying which antenna 110 is currently providing the signal (if any) being received by the receiver 112. By using information about the asset embedded in the signal received by the receiver 112 in conjunction with the antenna identification, the controller 116 can correlate the asset with the particular location associated with the antenna 110. Furthermore, the absence of any signal (due to no RFID tag 120 being present) indicates that no asset is currently located at that particular location.

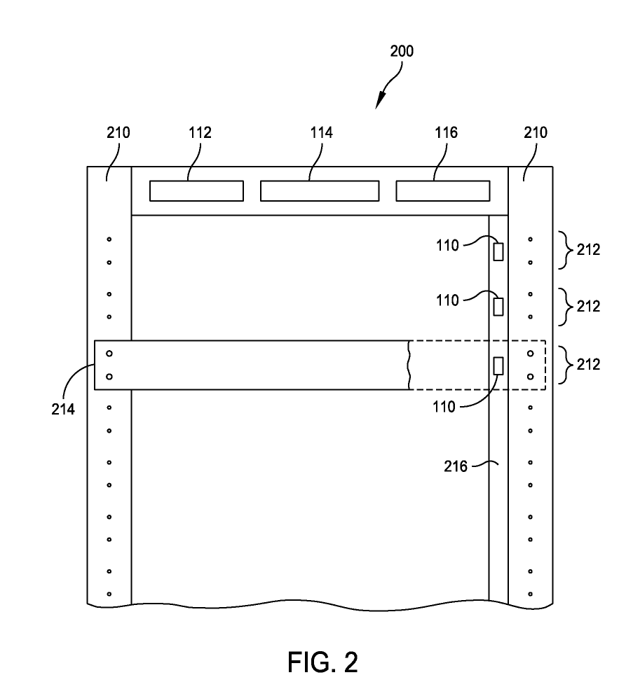

FIG. 2 depicts a front view of an exemplary equipment rack 200, the upper portion of which is shown. The rack 200 has front mounting rails 210 for mounting a piece of equipment, also referred to herein as an asset, configured for mounting on such rails 210. The rack 200 has multiple mounting positions 212 for horizontally mounting assets at various positions, also known as U-positions. The reader 112, the antenna selector 114, and the controller 116 may be mounted within the rack 200 as shown; however these devices may also be located elsewhere in the rack or outside the rack entirely according to a particular application.

According to one embodiment, the antennas 110, which may have close sensing ranges, are located at strategic locations in the equipment rack 200. In one example, the antennas 110 are located in one corner of the equipment rack 200. The location of each antenna 110 is in proximate relation to one of the U-positions 212. The antenna 110 may be mounted, for example, adjacent to the front or rear mounting rails. Assets 214 having the attached RFID tag 120 may be installed at one of the U-positions 212. Accordingly, when the asset 214 having an RFID tag attached at a position near the far corner of the asset 214 is mounted at one of the U-positions 212, the corresponding antenna 110 will receive the signal from the RFID tag. It should be appreciated that the placement of the antennas 110 and RFID tags may be varied according to a particular application with preferably at least one antenna 110 located at each U-position 212. For convenience in positioning the antennas 110 within the rack 200, the antennas 110 may be enclosed by a housing 216 mounted in the rack 200.

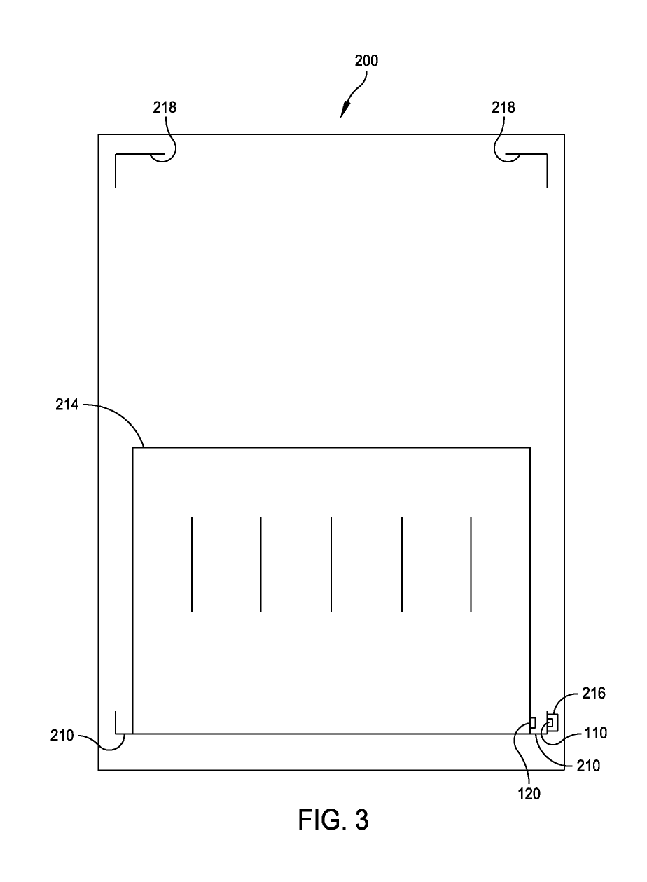

FIG. 3 depicts a cross-sectional top view of the exemplary rack 200 having front 210 and rear 218 mounting rails. Located adjacent to the front mounting rails 210 is the antenna 110 and its housing 216. Mounted in the rack 200 is the asset 214 having the RFID tag 120 attached at a position corresponding to the position of the antenna 110. Accordingly, when the asset 214 is properly mounted in the rack 200 at one of the U-positions the RFID tag 120 will be within the close sensing range of the corresponding antenna 110. In this exemplary embodiment the asset 214 is a half-depth device, meaning that it extends half of the distance from the front mounting rails 210 to the rear mounting rails 218. It should be appreciated that certain devices are full-depth devices, meaning that they may extend the entire distance rearward from the front mounting rails 210 to the rear mounting rails 218. In such instances it may be advantageous to position the antenna 110 in an alternative location, such as on or adjacent to the rear mounting rails 218 to accommodate such devices. In another embodiment, the antenna 110 may be mounted on a front, side, or rear door (not shown) of the rack 200, or at other location on the rack 200.

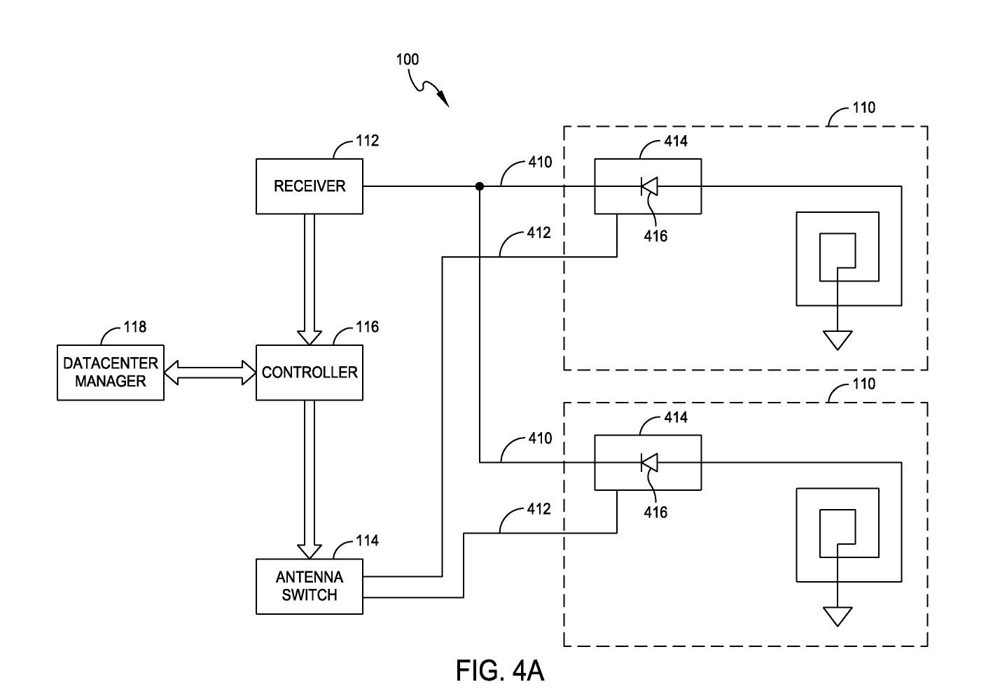

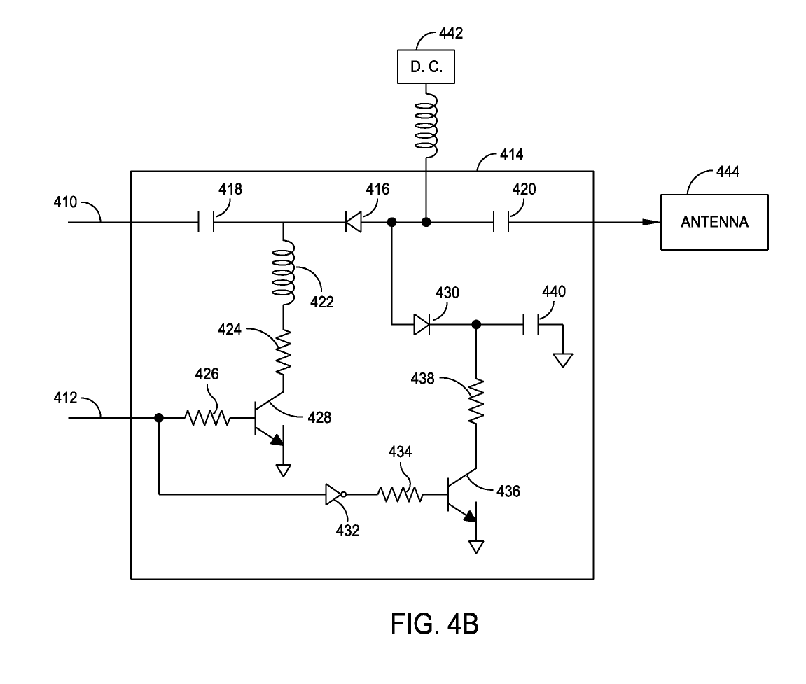

FIG. 4A depicts a schematic of the exemplary asset identification system 100, having a plurality of antennas 110, a receiver 112, an antenna switch 114, a controller 116, and a data center manager 118. Each of antennas 110 includes a signal line 410 and an enable line 412. Signal line 410 communicates a signal (e.g., generated by an RFID tag) received by antenna 110 to receiver 112. Each enable line 412 provides a control signal for enabling the corresponding antenna 110. The signal received by each antenna 110 is only passed to receiver 112 when the corresponding enable line 412 is active. Each antenna 110 may include an enable circuit 414 having a diode 416. Various embodiments of enable circuit 414 are described in further detail below. For example, in enable circuit 414, when antenna selector 114 provides the control signal over enable line 412, diode 414 is turned on, activating a small forward direct current through diode 414 which enables the tag signal to be communicated from antenna 110 to receiver 112. In another example, when no control signal is provided, diode 414 is turned off, and the tag signal is inhibited from being communicated from antenna 110 to receiver 112 by diode 416.

According to one embodiment, one or more RFID tags are passive or battery-assisted passive. An energizing field is applied to each tag to provoke a signal from the tag. The power source for the energizing field may be provided, for example, by an RFID reader device, such as a TRH031M integrated circuit (IC) chip, available from 3ALogics, or a similar device. In one embodiment, the RFID reader provides an alternating current (AC) power source for energizing a tag that is proximately located to an antenna. The AC power is transferred from the antenna to a tag antenna within the RFID tag through mutual inductance. In one example, the mutual inductance is defined by a coupling factor of approximately 0.07; however, it will be understood that other coupling factors may be effective. When the RFID tag is energized, the tag generates a signal that is received by the antenna. The signal is communicated from the antenna to the RFID reader or another receiver for processing.

FIG. 4B depicts a schematic of an exemplary enable circuit 414 in accordance with one embodiment. Enable circuit 414 includes a signal line 410 and an enable line 412, and is coupled to a power source, e.g., a DC power source 442, and an antenna 444. An RFID reader (not shown) is coupled to the signal line 410. The RFID reader provides an AC power source (distinct from DC power source 422) for energizing an RFID tag (not shown) proximately located to antenna 444. Signal line 410 is coupled at least to a diode 416, two capacitors 418 and 420, and DC power source 422. Enable circuit 414 also includes transistors 426 and 436 coupled to opposite ends of diode 416. Enable circuit 414 also includes various elements, including, for example, capacitors, referenced at 418, 420, and 440, diode 430, inductor 422, resistors 424, 426, 434 and 438, and inverter gate 432. It will be understood that these elements are exemplary and that other circuit configurations are possible.

In one example, enable circuit 414 acts as a switch between antenna 444 and a receiver or RFID reader (not shown) coupled to signal line 410. Passive or battery-assisted passive RFID tags may be used, and AC power to energize the tags may be provided by the receiver or RFID reader. Enable line 412 provides a control signal for controlling the switch, and signal line 410 provides a path for communicating the antenna signal through enable circuit 414, and a path for conducting power for energizing the tags from the receiver to antenna 444. For example, when enable line 412 is active (e.g., on), transistor 428 is switched on, enabling a voltage differential across diode 416, between DC power source 422 and ground, to turn diode 416 on and create a forward direct current bias across diode 416. The forward direct current enables the AC power to be transmitted through diode 416 to antenna 444. Energy from the AC power source is radiated by antenna 444, energizing the RFID tag. The energized RFID tag provides a signal that is received by antenna 444, and communicated through diode 416 to the receiver or RFID reader on signal line 410.

In another example, when enable line 412 is inactive (e.g., off), transistor 428 is switched off, causing diode 416 to turn off. Transistor 436 is switched on, enabling a voltage differential across diode 430, between DC power source 422 and ground, to turn diode 430 on, providing a path to ground for signal line 410. Any AC power on signal line 410 will be shorted to ground through diode 430, and any signal received by antenna 444 will be inhibited or blocked by diode 416.

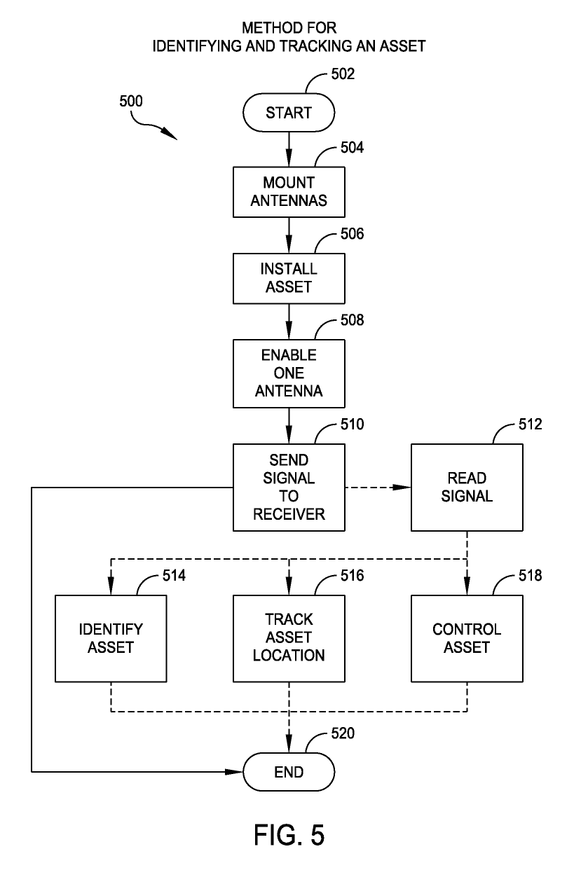

FIG. 5 depicts an exemplary process for identifying and tracking an asset 500. At block 502, the process begins. At block 504, a plurality of antennas are mounted in an equipment rack. The antennas are mounted such that each antenna is configured to receive a signal from an RFID tag attached to an asset mounted at one of a plurality of rack positions within the equipment rack. At block 506, an asset having the RFID tag is installed at one of the rack positions. When the asset is installed, the RFID tag is located within the sensing range of the antenna mounted at the corresponding rack position. At block 508, one of the antennas is selectively enabled to receive the signal from the RFID tag. The antenna may be selectively enabled by an antenna switch connected to the antenna. At block 510, the signal is sent to a receiver. The receiver may contain an RFID reader. At block 520, the process ends.

In another embodiment, indicated using dashed lines in FIG. 5, acts 512 to 518 occur after act 510. At block 512 the signal is read by the receiver to obtain data from the RFID tag. The data may include, but is not limited to, an RFID identifier, an asset identifier or other information in relation to the asset. The data may also include the location based on the antenna used to receive the data. In another embodiment, at block 514 the asset is identified based on the data. The asset may be identified, for example, by correlating a unique RFID identifier with a description of the asset in a database. In another example, the asset may be identified through other data received from the RFID tag. It will be understood that alternative methods of identifying the asset may be employed based on the data received from the RFID tag.

In yet another embodiment, at block 516 the location of the asset is tracked based on the data. The location of the asset may be identified, for example, by correlating the RFID identifier with a location stored in a database. In another example, a rack controller is connected to the receiver and the antenna switch. The rack controller combines data received from the RFID tag with information about which antenna was selected the time the data was received to determine the location of the asset. In yet another embodiment, at block 518 the asset is controlled based on the data. The control may include, but is not limited to, take an action, such as indicate an alarm, turn the asset off or on, log an event, or maintain an inventory of the asset.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

For example, embodiments of the invention may include antennas configured to receive signals from devices other than RFID tags, such as transponders, optical bar code readers and the like. Embodiments of the invention may include mounting antennas in locations other than equipment enclosures, such as near doorways for tracking the movement of assets in and out of a room. Embodiments of the invention may include utilizing alternative systems and methods of asset inventory management based on the data received from the RFID tags. Furthermore, the RFID tags may be attached to the asset in a myriad of ways, such as to a power supply cable connected to the asset.

What is claimed is:

1. An asset identification and tracking system comprising:
a plurality of antennas each constructed and arranged to be mounted to one of a plurality of rack positions within an equipment rack;
a receiver coupled to each of the plurality of antennas; and
an antenna selector coupled to each of the plurality of antennas to selectively enable communication between one of the plurality of antennas and the receiver.

2. The system set forth in claim 1, further comprising a controller coupled to the receiver and to the antenna selector.

3. The system set forth in claim 2, further comprising a data center manager coupled to the controller and configured to identify and track an asset based on information received from the controller.

4. The system set forth in claim 1, wherein each of the plurality of antennas is configured to receive a signal emitted by a RFID tag attached to an asset mounted within the equipment rack.

5. The system set forth in claim 1, wherein the receiver includes an RFID reader.

6. The system set forth in claim 1, wherein each of the plurality of antennas comprises a signal line and an enable line, wherein the signal line is coupled to the receiver, wherein the enable line is coupled to the antenna selector, and wherein each of the plurality of antennas is configured to communicate a signal over the signal line to the receiver when an electrical current is applied, by the antenna selector, to the enable line of a respective one of the plurality of antennas.

7. The system set forth in claim 6, wherein each of the plurality of antennas further comprises an enable circuit coupled to the enable line and to the signal line.

8. The system set forth in claim 7, wherein the enable circuit comprises a diode.

9. The system set forth in claim 1, wherein the plurality of antennas is enclosed within at least one housing.

10. A method for identifying and tracking an asset comprising:
mounting each of a plurality of antennas in an equipment rack such that each of the plurality of antennas is configured to receive a signal from an RFID tag attached to an asset mounted at one of a plurality of rack positions within the equipment rack;
installing the asset having the RFID tag at the one of the plurality of rack positions;
selectively enabling one of the plurality of antennas to receive the signal from the RFID tag; and
sending the signal to a receiver.

11. The method set forth in claim 10, further comprising reading, by the receiver, the received signal to obtain data from the RFID tag.

12. The method set forth in claim 11, further comprising identifying the at least one asset based on the data.

13. The method set forth in claim 11, further comprising tracking a location of the at least one asset based on the data.

14. The method set forth in claim 11, further comprising controlling the at least one asset based on the data.

15. An asset identification and tracking system comprising:
a plurality of antennas configured for mounting within an equipment rack; and
means, coupled to the plurality of antennas, for sensing an RFID tag associated with an asset mounted in the equipment rack and for identifying a location of the asset in the equipment rack.

16. The system set forth in claim 15, further comprising means for identifying the asset.

17. The system set forth in claim 15, further comprising means for tracking a location of the asset.

18. The system set forth in claim 15, further comprising means for controlling the asset.
